(19) United States
(12) Patent Application Publication
(10) Pub. No.: US 2015/0049592 A1
(43) Pub. Date: Feb. 19, 2015

(54) Systems and Methods for Random Snooze Duration

(71) Applicant: Dennis William Braswell, Mobile, AL (US)

(72) Inventor: Dennis William Braswell, Mobile, AL (US)

(21) Appl. No.: 14/456,349

(22) Filed: Aug. 11, 2014

Related U.S. Application Data
(60) Provisional application No. 61/865,606, filed on Aug. 13, 2013.

(51) Int. Cl. G04G 13/02

(52) U.S. Cl. CPC G04G 13/023
USPC 368/250

(57) ABSTRACT

An alarm system is provided that includes an alarm and a snooze system. The snooze system is operable to suspend the alarm for at least one snooze duration, wherein the length of the snooze duration is random. In some embodiments, the random snooze durations may be selected by shuffling a set of predetermined snooze durations, and in others the random snooze duration may have a minimum or maximum duration.

### CROSS-REFERENCE TO RELATED APPLICATION AND PRIORITY INFORMATION

This application claims the benefit of co-pending, prior filed U.S. provisional application no. 61/865,606, entitled “Systems and Methods for Random Snooze Duration,” filed Aug. 13, 2013. That provisional application is hereby incorporated by reference.

### TECHNICAL FIELD OF THE INVENTION

This invention relates generally to alarms, and more particularly to systems and methods for snooze functions.

### BACKGROUND OF THE INVENTION

Alarms are well known, and exist in many forms, including, without limitation, as embodied in bedside alarm clocks, on personal computers (PCs), tablet PCs, and smart phones. Many of these alarms include a snooze function.

Of course, an alarm sounds at a time set by the user. Alarms usually sound with an audible indication, but can employ any indication, including, without limitation, those that are audible, visible, those that vibrate, or those that send or display some kind of message or signal (such as, also without limitation, email, reminder message, phone call, text message, or light flash), or any combination thereof. Use of any alarm indication is sometimes referred to herein as sounding or initiating the alarm.

With a snooze function, an alarm is suspended for a predetermined period of time, after which the alarm sounds again. The designer of the system usually sets this predetermined period of time. With some alarm systems, a user may be given the option to select the duration of the snooze period (for example, 5 minutes).

One particular application for the snooze function is waking Many people have trouble waking, or at least are not ready or willing to arise when an alarm initially sounds. The snooze is useful for such people, because it allows more time in bed but does not disable the alarm—it merely suspends the alarm for a period of time. Thus, the alarm function is still active and useful for waking. Of course, the snooze function is not limited to waking applications, but is also used simply postpone an alarm (such as, for example, a reminder alarm).

The snooze function can be improved, however, to more effectively assist people in getting out of bed sooner, or to more effectively prompt a response to an alarm.

### SUMMARY OF THE INVENTION

In accordance with the teachings of the present invention, methods and apparatus for random snooze durations are provided which improve prior art systems.

In one embodiment, an alarm system is provided which includes an alarm and a snooze system operable to suspend the alarm for a snooze duration, wherein the snooze duration is random. The alarm system may further include a user interface operable to set the snooze duration to be random. The user interface may also be operable to set a minimum or maximum snooze duration for the snooze duration.

The snooze system may also be operable to suspend the alarm for a plurality of snooze durations, wherein at least two of the snooze durations are random. In some embodiments, the random snooze duration is less than about 3 minutes. In some embodiments, the snooze system is operable to suspend the alarm for one or more random snooze durations, and wherein the one or more random snooze durations are established by shuffling a set of predetermined snooze durations.

In another embodiment, an alarm system is provided which includes an alarm and a snooze system operable to suspend the alarm for a plurality of random snooze durations. The alarm system may also include a user interface operable to set the snooze durations to be random. The user interface may also be operable to set a minimum or maximum snooze duration for the random snooze durations.

In one embodiment, the random snooze durations are established by shuffling a set of predetermined snooze durations. In some embodiments, at least one of the random snooze durations is less than about 3 minutes.

Also provided is a method of alarming, which, in one embodiment, includes initiating an alarm and suspending the alarm for a random snooze duration. The method may also include allowing a user to set the snooze duration to be random, or setting a minimum or maximum snooze duration for the random snooze duration.

In another embodiment, suspending the alarm comprises suspending the alarm for a plurality of random snooze durations. Also, in some embodiments, the random snooze duration may less than about 3 minutes. In another embodiment, suspending the alarm includes suspending the alarm for one or more random snooze durations, and wherein the one or more random snooze durations are established by shuffling a set of predetermined snooze durations.

Important technical advantages are provided herein, including, without limitation, the disruption of predictable snooze durations, which provides an effective way to induce a user to arise out of bed or otherwise respond to an alarm. Another important technical advantage is the ability to tailor the minimum and maximum times of the random snooze duration.

### BRIEF DESCRIPTION OF THE DRAWINGS

Reference is made in the description to the following briefly described drawings, wherein like reference numerals refer to corresponding elements:

FIG. 1 is a block diagram of one embodiment of a system according to the teachings of the present invention; and

FIG. 2 is flow chart of one embodiment of a system according to the teachings of the present invention.

### DETAILED DESCRIPTION OF THE INVENTION

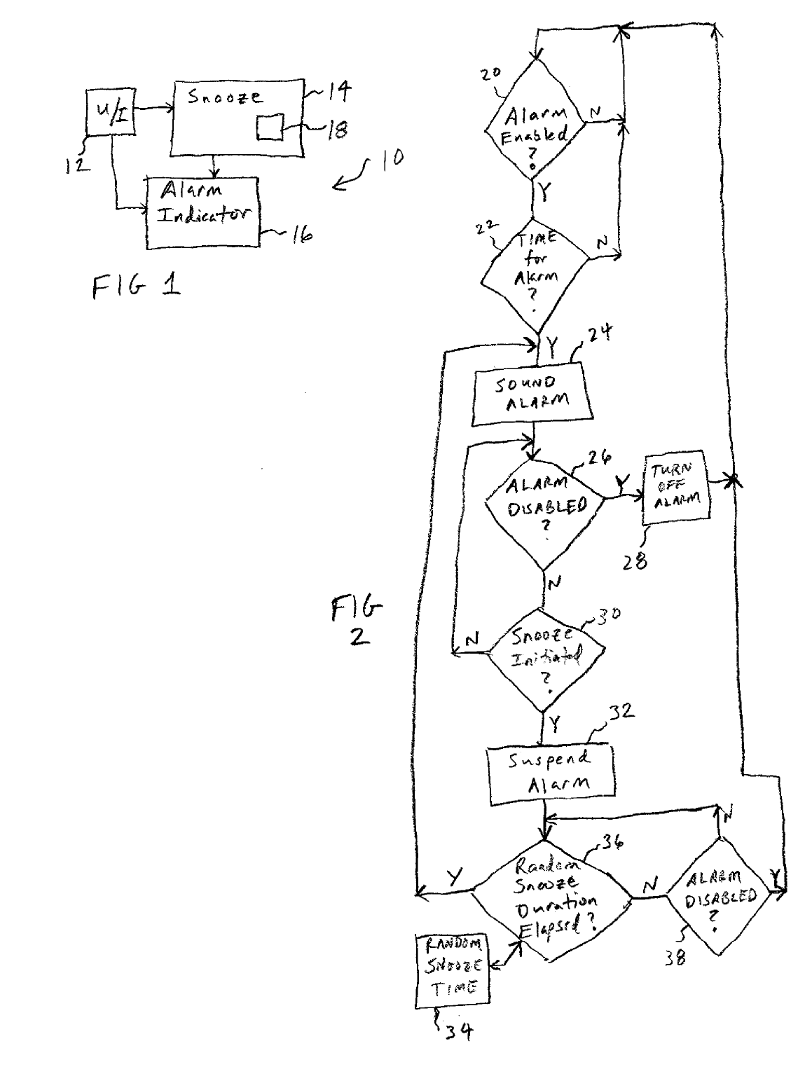

FIG. 1 is a block diagram of one embodiment of an alarm system 10 according to the teachings of the present invention. As shown in FIG. 1, alarm system 10 includes a user interface 12 coupled to a snooze system 14 and an alarm indicator 16. Snooze system 14 is also coupled to the alarm indicator 16. Indicator 16 may employ any kind of alarm indication, including, without limitation, those that are audible, visible, those that vibrate, or those that send or display some kind of message or signal (such as, also without limitation, email, reminder message, phone call, text message, or light flash), or any combination thereof.

Snooze system 14 includes, or coordinates with, a random time generator system 18 to generate one or more random time durations for the snooze durations. In one embodiment, system 18 may include a random number generator, from which the system 18 or snooze system 14 generates random snooze durations. Any suitable approach may be used for generating random time durations.

Within this description, the term “random” is used in a broad sense, and is not limited to mean truly random only. In addition to truly random, “random” includes pseudo random, approximately random, apparently random, and reasonably unpredictable. Furthermore, as discussed below, in some embodiments of the present invention, a snooze duration is bounded by a minimum duration or a maximum duration, which is still considered random herein. Also, in some embodiments of the present invention, one or more snooze durations are selected by shuffling a set of predetermined snooze durations, which is still considered random herein.

The user interface 12 may be any suitable interface to allow a user to set the alarm and use the snooze features. For example, and without limitation, the user interface may include software and a touch screen or other graphical interface, or, as in some alarm clocks, buttons. The user interface 12 allows the user to, among other things, set an alarm time, to enable or disable the alarm, to select snooze, and to set snooze features of the present invention.

In particular, the user may select the snooze durations to be random amounts of time. In addition, the user may set a minimum snooze duration that the random snooze duration may not be less than. Similarly, the user may set a maximum snooze duration that the random snooze duration may not be greater than. The snooze system 14 receives the user input from the user interface, and uses it to generate the appropriate snooze durations.

As an example of one particular use, a user sets an alarm time, and sets the snooze to random. When the alarm time is reached, the indicator is activated. The user then selects snooze, which suspends the alarm. Because snooze has been set to random, the length of time the alarm will be suspended is random. Thus, the indictor will sound again after a random duration. If the user selects snooze again, the alarm will again be suspended by another random amount of time, after which the indictor will sound again. The user may disable the alarm at any time.

FIG. 2 is a flow chart of one embodiment of the present invention. As shown in FIG. 2, the system evaluates, at decision block 20, whether the alarm has been enabled. Once the alarm is enabled, the process flows to decision block 22, wherein the process evaluates whether the time to sound the alarm has been reached. If not, the process loops back to decision block 20. If the alarm time has been reached, the alarm indicator is sounded at block 24. After block 24, the process evaluates, at decision block 26, whether the alarm has been disabled. If it has been disabled (whether by the user or otherwise (such as, without limitation, after a preset amount of time)), the process flows to block 28 to disable the alarm indicator and then back to decision block 20. If the alarm has not been disabled, the process flows to decision block 30.

At decision block 30, the process evaluates whether snooze has been initiated (e.g., the user hits snooze after the alarm sounds). If snooze has not been initiated, then the process flows back to decision block 26. If snooze has been initiated, then the alarm indicator is suspended at block 32. The system establishes or accesses a random snooze duration from block 34, which may occur at any appropriate time. At decision block 36, the system evaluates whether this random snooze duration has elapsed. If the random snooze duration has not elapsed, then the process evaluates, at decision block 38, whether the alarm has been disabled. If it has been disabled, the process flows back to decision block 20. If the alarm has not been disabled, then the process flows back to decision block 36. If, at decision block 36, it is determined that the random snooze time has elapsed, then the process flows back to block 24, where the alarm indicator is sounded.

Although a particular order is shown in FIG. 2, changes can be made without departing from the intended scope of the invention.

The random snooze duration of the present invention introduces an important character to the snooze situation: uncertainty. The duration of alarm suspension is random, and so, for example, the alarm may sound again in 10 minutes, or in less than 1 minute. This uncertainty can have the effect of unsettling the user so as to more effectively induce the user to arise or otherwise respond to the alarm. One particularly effective way of creating the uncertainty is to employ short snooze durations, which occur randomly. Having the alarm sound again a relatively short time after hitting snooze is an effective inducement to rising or otherwise responding to an alarm.

Another aspect of one embodiment of the present invention is causing one or more of the random snooze durations, for example and without limitation, every other one or every third one, to be relatively short. By relatively short, times of less than about 3 or 4 or 5 minutes, for example, may be chosen. Short snooze durations can be unsettling.

The random time generator system 18 generates (or is used to generate) random time durations in any appropriate way, for example and without limitation, by using a random number generation algorithm. However, as discussed above, random has a broad meaning herein, and other approaches may be used to generate reasonably unpredictable—random—snooze durations. For example, a set of predetermined snooze durations may be “shuffled” (which includes, without limitation, selecting randomly from the set) to select an unpredictable snooze duration or to create an unpredictable sequence of varying snooze durations. Such an embodiment and its snooze duration lengths are considered “random” herein. Also, as discussed above, forcing the occurrence of one or more short duration snooze durations may be preferable, and such an approach and its snooze duration length or lengths are also considered “random” herein.

In one particular embodiment, the random snooze duration, however determined, is established or accessed from block 34 of the flow diagram of FIG. 2.

Other combinations are additional aspects of some embodiments of the present invention, but are not necessary. For example, the random snooze durations may be combined with non-random snooze durations. Also, the user may set the maximum number of snooze durations, and an amount of time after which the alarm is automatically disabled. Furthermore, any of the examples used herein may be combined with others.

In addition, some of these features may have a default setting set by the system designer. For example, the maximum random snooze duration should have a default setting, although such a setting is not necessary. As an example, a designer might set the maximum random snooze duration to 10 minutes. Conversely, the minimum random snooze duration might not have a minimum default setting, although it may.

“Alarm” as used herein refers to any device, mechanism, or system for signaling a particular time, and includes, without limitation, software or firmware, and combinations of either or both with hardware, such as found in smart phones and PCs. An alarm may be integrated with a clock, coordinate with a clock, or be separate from a clock.

The particular embodiments and descriptions provided herein are illustrative examples only, and features and advantages of each example may be interchanged with, or added to the features and advantages in the other embodiments and examples herein. Moreover, as examples, they are meant to be without limitation as to other possible embodiments, are not meant to limit the scope of the present invention to any particular described detail, and the scope of the invention is meant to be broader than any example. Also, the present invention has several aspects, as described above, and they may stand alone, or be combined with some or all of the other aspects.

And, in general, although the present invention has been described in detail, it should be understood that various changes, alterations, substitutions, additions and modifications can be made without departing from the intended scope of the invention, as defined in the following claims.

What is claimed is:

1. An alarm system, comprising:
an alarm; and
a snooze system operable to suspend the alarm for a snooze duration, wherein the snooze duration is random.

2. The alarm system of claim 1, and further comprising a user interface operable to set the snooze duration to be random.

3. The alarm system of claim 1, and further comprising a user interface operable to set a minimum snooze duration for the snooze duration.

4. The alarm system of claim 1, and further comprising a user interface operable to set a maximum snooze duration for the snooze duration.

5. The alarm system of claim 1, wherein the snooze system is operable to suspend the alarm for a plurality of snooze durations, wherein at least two of the snooze durations are random.

6. The alarm system of claim 1, wherein the snooze duration is less than about 3 minutes.

7. The alarm system of claim 1, wherein the snooze system is operable to suspend the alarm for one or more random snooze durations, and wherein the one or more random snooze durations are established by shuffling a set of predetermined snooze durations.

8. An alarm system, comprising:
an alarm; and
a snooze system operable to suspend the alarm for a plurality of random snooze durations.

9. The alarm system of claim 8, and further comprising a user interface operable to set the snooze durations to be random.

10. The alarm system of claim 8, and further comprising a user interface operable to set a minimum snooze duration for the random snooze durations.

11. The alarm system of claim 8, and further comprising a user interface operable to set a maximum snooze duration for the random snooze durations.

12. The alarm system of claim 8, wherein the random snooze durations are established by shuffling a set of predetermined snooze durations.

13. The alarm system of claim 8, wherein at least one of the random snooze durations is less than about 3 minutes.

14. A method of alarming, comprising:
initiating an alarm; and
suspending the alarm for a random snooze duration.

15. The method of claim 14, and further comprising allowing a user to set the snooze duration to be random.

16. The method of claim 14, and further comprising setting a minimum snooze duration for the random snooze duration.

17. The method of claim 14, and further comprising setting a maximum snooze duration for the random snooze duration.

18. The method of claim 14, wherein suspending the alarm comprises suspending the alarm for a plurality of random snooze durations.

19. The method of claim 14, wherein the random snooze duration is less than about 3 minutes.

20. The method of claim 14, wherein suspending the alarm comprises suspending the alarm for one or more random snooze durations, and wherein the one or more random snooze durations are established by shuffling a set of predetermined snooze durations.
